(19) United States
(12) Patent Application Publication
(10) Pub. No.: US 2004/0050288 A1
(43) Pub. Date: Mar. 18, 2004

(54) Dispersions

(76) Inventors: John Martin Geary, Manchester (GB); William Albert Fern, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 10/467,315

(22) PCT Filed: Jan. 10, 2002
(86) PCT No.: PCT/GB02/00078

(30) Foreign Application Priority Data
Feb. 7, 2001 (GB) 0102974.3

(51) Int. Cl. C09D 1/00

(52) U.S. Cl. 106/31.01

(57) ABSTRACT

A composition for ink jet printing of a synthetic substrate comprising a disperse dyestuff having an average particle size of from 10 to 500 nm, a dispersant, water and a water-miscible co-solvent having a degree of polarity (δ/MPa^{1/2}) of from 4 to 14 at 25° C. such as ethyleneglycol, glycerol, 1,4-butanediol and resorcinol.

The present invention relates to dispersions of disperse dyestuffs in aqueous-based media for the printing of synthetic substrates such as textile materials and sheet transparencies in non-impact ink jet printing.

In conventional textile printing using screen, roller and gravure printing processes for applying disperse dyestuffs to synthetic material substrates the disperse dyestuff is dispersed in an aqueous medium by means of a dispersant and the particle size of the disperse dyestuff typically ranges from 50 nm to 1000 nm or larger. Such particle sizes are unsuitable for application in non-impact ink jet printing since the larger particles tend to block the small jets in the print head.

In order to reduce the tendency to block the nozzles in the ink jet print head the particle size of the disperse dyestuff should be less than 300 nm average diameter but this causes other problems as discussed below.

Furthermore, stability problems are often encountered when the conventional aqueous dispersions are stored over long periods, especially under adverse storage conditions, owing to the presence of the large particle sizes of the disperse dyestuff. Stability can be improved by including polymeric thickeners but this often results in a high viscosity of the print formulation containing the disperse dyestuffs, especially when the disperse dyestuff is present at high concentration. Typical viscosities of conventional aqueous print formulations containing disperse dyestuffs range from 60 to 180 cps measured at 25° C. Such high viscosities are unsuitable for printing by ink jet processes because of the reduction in recovery of the ink in the fine nozzles of the ink jet print head following the pulsed ejection of the ink. This occurs when the ink is ejected by both bubble and piezo techniques and results in loss of sharpness of the printed mark. For ink jet printing with disperse dyestuffs the aqueous ink formulation should have a viscosity below 40 cps and preferably below 15 cps measured at 25° C.

An important component of ink jet print formulations is a water-miscible co-solvent or humectant. The purpose of this co-solvent is to reduce the tendency of the ink to dry out on the surface of the print head, especially in thermal ink jet printing processes, and also to help redissolve any disperse dyestuff which deposits on the print head. Typical co-solvents are polyhydric alcohols such as diethyleneglycol as disclosed in U.S. Pat. No. 6,099,627.

The choice of co-solvent is crucial to the stability of aqueous-based ink jet formulations because the combination of certain co-solvents and the smaller particles of disperse dyestuffs, especially particles having an average diameter of less than 50 nm can result in crystal growth, particularly under warm storage conditions and in thermal ink jet printing and this manifests itself in loss of sharpness of the printed mark, increased tendency to block the nozzles of the print head and a reduction in uniformity and fastness properties of the printed mark. This crystal growth of particles of disperse dyestuff is often referred to as “Ostwald ripening” as discussed, for example, in “Crystallisation” by J W Mullin, 3^{rd} edition, published by Butterworth/Heinemann, paperback edition, 1997, pages 288 to 290.

It has now been found that the susceptibility of the disperse dyestuff to crystal growth can be reduced if the co-solvent exhibits a solubility parameter for δ polarity (δ/MPa^{1/2}) of less than 14 as measured at 25° C. The solubility parameters are discussed in “Handbook of Solubility Parameters and other Cohesion Parameters” by A F M Barton, CRS Press, Boca Raton, Fla., pages 153 to 161.

According to the invention there is provided a composition comprising a disperse dyestuff having an average particle size of from 10 to 500 nm, a dispersant, water and a water-miscible co-solvent having a solubility parameter for degree of polarity from 4 to 14 (δ/MPa^{1/2}) at 25° C.

Preferably, the average particle size of the disperse dyestuff is not greater than 400 nm, more preferably not greater than 300 nm and especially not greater than 200 nm, for example, not greater than 100 nm.

The degree of polarity of the co-solvent is preferably not greater than 13 and especially not greater than 12.5 at 25° C. It is also preferred that the degree of polarity is not less than 6, more preferably not less than 8 and especially not less than 10 at 25° C.

Examples of water-miscible co-solvents having a degree of polarity between 10 and 14 measured at 25° C. are diethylenetriamine (13.3), dimethylformamide (13.7), methanol (12.3), allylalcohol (10.8), nonyl phenoxyethanol (10.2), dimethyl acetamide (11.5) and the polyhydric alcohols ethyleneglycol (11.0), glycerol (12.11), 1,3-butanediol and 1,4-butanediol (10.0) and triethyleneglycol (12.5).

The water-miscible co-solvent also preferably has a solubility parameter as determined by δ H-bonding (δ/MPa^{1/2}) at 25° C. which is greater than 20.5. Preferably the δ —H-bonding is not greater than 40 and especially not greater than 35 at 25° C. Examples of such water-miscible co-solvents are ethanolamine (21.3), methanol (22.3), resorcinol (21.1), 1,3-butanediol (21.5), propyleneglycol (23.3), ethyleneglycol (26.0) and glycerol (29.3).

The preferred co-solvents are ethyleneglycol and glycerol which show marked advantage over diethyleneglycol (δ polarity of 14.7 and δ H-bonding of 20.5 as measured at 25° C.).

The disperse dyestuff may be any class of disperse dyestuff listed in the Colour Index including any supplements and additions thereto. These include azo, disazo, anthraquinone, benzodifuranone and phthalocyanine dyestuffs, including mixtures thereof.

Examples of suitable yellow disperse dyestuffs are C I Disperse Yellows 5, 42, 54, 79, 83, 99, 119, 126, 160, 198 and 224.

Examples of suitable orange disperse dyestuffs are C I Disperse Oranges 13, 25, 29, 37, 44, 49, 66 and 119.

Examples of suitable red disperse dyestuffs are C I Disperse Reds 54, 60, 72, 82, 86, 91, 92, 111, 126, 135, 145, 164, 181, 221, 331 and 348.

Examples of suitable blue and violet disperse dyestuffs are C I Disperse Blues 56, 60, 72, 73, 79, 87, 113, 128, 143, 165 and 359 and Disperse Violet 33.

Examples of suitable green disperse dyestuffs are C I Disperse Greens 6.1 and 9.

The disperse dyestuff may also be present as a mixture and especially a mixture of blue containing orange, yellow or red disperse dyestuffs which give a black shade. Typically, the amount of blue disperse dyestuff(s) in the black mixture is from 70 to 90% by weight of the mixture. Examples of suitable black mixtures are CI Disperse Blue 359, CI Disperse Blue 72, CI Disperse Orange 25 and CI Disperse Yellow 54; and CI Disperse Blue 79, CI Disperse Orange 44 and CI Disperse Red 331.

The dispersant is preferably non-ionic and especially anionic.

Preferred non-ionic dispersants are alkoxylate derivatives of C₁₋₃₀-alk(en)yl alcohols, C₁₋₂₀-alkylphenols and naphthols. Preferably the alkoxylate is obtained by (co)polymerising a C₂₋₄-alkyleneoxide such as ethyleneoxide (EO), propylene oxide (PO) and butylene oxide (BO). It is much preferred that the alkylene oxide is ethylene oxide, optionally containing up to 20% molar propyleneoxide. Specific examples are nonylphenol 10-20 EO, β-naphthol 10-20 EO and C₁₂₋₁₈-alkyl alcohols 10-20 EO.

Preferred anionic dispersants are lignosulphonates, phenyl and naphthyl sulphonic acid formaldahyde condensates and alkoxylates containing one or more carboxylic acid, sulphonic acid or phosphonic acid groups. Important anionic dispersants are the nonionic alkoxylate dispersants mentioned above which are subsequently reacted with dicarboxylic acids or anhydrides thereof such as maleic and succinic anhydrides and dispersants containing one or more methylenephosphonate groups attached to nitrogen of a C₂₋₄-alkeneoxy mono- or di-amine such as the Jeffamine polymers available from Huntsman Corporation.

The amount of dispersant is preferably from 5 to 150% based on the amount of disperse dyestuff in the composition. Preferably, the amount of dispersant is not less than 10% and especially not less than 20% based on the amount of disperse dyestuff. It is also preferred that the amount of dispersant is not greater than 100%, more preferably not greater than 70% and especially not greater than 50% based on the amount of disperse dyestuff in the composition.

The amount of disperse dyestuff in the composition is preferably from 0.1% to 60% based on the total amount of the composition.

It is preferred that the composition is prepared by milling the disperse dyestuff in concentrated form as a millbase which is subsequently diluted to give the final ink jet formulation. The amount of disperse dyestuff in the millbase is preferably not less than 5%, more preferably not less than 10% and especially not less than 20% based on the weight of millbase. It is also preferred that the amount of disperse dyestuff in the millbase is not greater than 50% and especially not greater than 40% based on the amount of millbase.

Although the millbase may contain the co-solvent(s), it is preferable to mill the disperse dyestuff and dispersant together in the presence of water alone and to add the co-solvent when the composition is diluted to give the final ink jet formulation. The dilution of the millbase to give the final ink jet formulation is generally carried out by the addition of water and one or more co-solvents although other adjuncts which are commonly used in ink jet printing may also be added. Examples of other adjuvants are defoamers such as 2, 4, 7, 9-tetramethyl-5-decyne-4,7-diol (Surfynol 104E ex Air Products) blends of hydrocarbons, fats, waxes and non-ionic emulsifiers such as Foamaster NXZ ex Henkel-Nopca Ltd, mineral oil-based emulsions such as Bevaloid 6001 ex Rhone-Poulene and so-called crystal growth inhibitors such as nonyl-phenol ethoxylate phosphate esters such as Phospholan PNP 9 ex Akros Chemicals.

The amount of disperse dyestuff in the final ink jet formulation is preferably from 0.1% to 20% based on the total amount of the formulation. Preferably, the amount of disperse dyestuff in the formulation is not less than 1%, more preferably not less than 4% and especially not less than 6% based on the total mount of the ink jet formulation

The amount of co-solvent(s) in the ink jet formulation is preferably from 5% to 30% based on the total amount of the ink jet formulation. Preferably the amount of co-solvent is not greater than 25% and especially not greater than 20% based on the total amount of the ink jet formulation. It is also preferred that the amount of co-solvent(s) is not less than 7% and especially not less than 10% based on the total amount of the ink jet formulation.

The composition according to the invention may be prepared by any method known to the art for dispersing a particulate solid uniformly throughout an aqueous continuous phase. Thus, the composition may be prepared using a vessel-driven media mill such as a roll mill, a ball mill, a centrifugal mill or a planetary mill; a high speed rotary mill such as a sand mill, a media agitator mill such as an agitator tank mill or by using a high pressure micro fluidiser. Milling is continued until the average particle size attains the desired size. If the composition is a concentrated millbase it is removed from the mill and separated from the attrition medium prior to dilution with the letdown, such as water and co-solvent.

The final ink jet formulation is preferably filtered to remove any particles having an average partial diameter greater than 500 nm.

In order that the ink jet formulation exhibits acceptable recovery in the fine nozzles of the print head following pulsed ejection of the ink, the ink preferably exhibits a viscosity of from 1 to 40 cps, more preferably from 1 to 20 cps and especially from 1.5 to 10 cps as measured at 25° C.

The ink jet formulation may contain other adjuncts which are commonly used in ink jet formulations such as preservatives, for example 1, 2-benzisothiazolin-3-one, isothiazolinones such as 2-methyl-4, 5-trimethyleneisothiazolin-3-one, 2-methylisothiazolin-3-one and 5-chloro-2-methylisothiazolin-3-one, including mixtures thereof.

As disclosed hereinbefore, the composition according to the invention is used in ink jet printing and as such may be sold in renewable cartridges. Hence, according to a further aspect of the invention there is provided a cartridge containing one or more outlets and a chamber containing the ink jet formulation according to the invention connected to each outlet.

Also, as disclosed hereinbefore, the composition according to the invention can be used for the printing of synthetic substrates, which may be a textile substrate or a sheet material. The synthetic substrate may be a polyamide such as nylon 6,6 or nylon 6,10, cellulose diacetate or triacetate or especially a polyester such as polyethylene teraphthalate. The textile substrate may be woven, knitted or non-woven. The non-woven substrate may comprise loose fibres in the form of web or is preferably in the form of a sheet, especially a transparent sheet. The non-woven substrate may also be in the form of a laminate comprising the synthetic substrate supported on a layer which is not capable of being dyed using disperse dyestuffs, for example paper.

After application of the ink to the synthetic substrate, the substrate is generally subjected to a heat treatment in order to promote the diffusion of the disperse dyestuff within the substrate. Such heat treatment may be steaming at from 100 to 120° C. or by dry heat treatment at from 180 to 220° C. Thus, as a further aspect of the invention there is provided a process for printing a synthetic substrate using the composition according to the invention followed by a heat treatment to develop the printed mark.

Following the heat treatment, any loose disperse dyestuff on the surface of the synthetic substrate may be removed by conventional means such as reduction clearing, treatment with alkali or washing in the presence of a surfactant. Whereas such treatment may be beneficial in the case of textile substrates it is not normally required in the case of substrates in sheet form, especially transparencies or other display substrates.

The invention is further illustrated by the following non-limiting examples wherein all references are to parts by weight unless expressed to the contrary.

### EXAMPLE 1

A red disperse dyestuff (80 Parts, Disperse Red 82 as Serilene Red 3B-LS ex Yorkshire Chemicals), nonionic dispersant (50.4 Parts, Solsperse 27000 ex Avecia Ltd), antifoam (0.8 Parts Surfyinol 104E ex Air Products) and water (269 Parts) were milled together in a Netzsch horizontal bead mill for 8 hours at 25° C. and 3000 rpm in the presence of 0.6-0.8 mm diameter Zirconia beads (200 ml). The resultant millbase was separated from the beads which were washed with water and the washings added to the millbase giving a millbase containing 15% by weight disperse dyestuff. The disperse dyestuff in the millbase has an average partial size of 100-200 nm as measured using a Malvern Zetasizer 3000HS.

An ink jet printing ink was prepared by diluting this millbase with water and co-solvent so that the final ink contained 8% disperse dyestuff, 0.15% antimicrobial agent, 0.5% crystal growth inhibitor and 20% co-solvent based on the total amount of printing ink.

The printing ink was stored at 25 and 40° C., respectively, and examined at weekly intervals for crystal growth using a Malvern Zetasizer 3000 HS. The results are given in Table 1 below which clearly show that ink jet printing inks containing diethyleneglycol (8 polarity=14.7, δ —H-bonding 20.5) results in marked crystal growth compared with ink containing ethylene glycol (δ polarity=11.0, δ —H-bonding=26.0) and glycerol (δ polarity=12.1, δ —H-bonding=29.3) as co-solvent.

TABLE 1

| Co-solvent | None | | DEG | | EG | | GLY | |
|---|---|---|---|---|---|---|---|---|
| Storage (days | 25° C. | 40° C. | 25° C. | 40° C. | 25° C. | 40° C. | 25° C. | 40° C. |
| 0 | 177 | 177 | 177 | 177 | 177 | 177 | 177 | 177 |
| 1 | 193 | 242 | 184 | 268 | 190 | 234 | 202 | 220 |
| 2 | 213 | 242 | 211 | 371 | 206 | 239 | 208 | 234 |
| 3 | 214 | 225 | 214 | 511 | 207 | 228 | 212 | 228 |
| 4 | 201 | 232 | 197 | 505 | 200 | 225 | 210 | 238 |

Footnote to Table 1
The numerical values are average particle diameters (nm)
DEG is diethylene glycol
EG is ethylene glycol
GLY is glycerol

### EXAMPLE 2

Example 1 was repeated except using an equal amount of an anionic dispersant, lignosulphonate (Diwatex 40 ex Borregaard Lignotech) in place of the non-ionic dispersant. The results are given in Table 2 below which clearly show that the diethyleneglycol promotes crystal growth whereas neither ethyleneglycol nor glycerol promote growth.

TABLE 2

| Co-solvent | None | | DEG | | EG | | GLY | |
|---|---|---|---|---|---|---|---|---|
| Storage (days | 25° C. | 40° C. | 25° C. | 40° C. | 25° C. | 40° C. | 25° C. | 40° C. |
| 0 | 171 | 171 | 171 | 171 | 171 | 171 | 171 | 171 |
| 1 | 167 | 158 | 156 | 182 | 166 | 157 | 181 | 162 |
| 2 | 172 | 161 | 161 | 198 | 168 | 160 | 175 | 163 |
| 3 | 169 | 158 | 161 | 211 | 167 | 157 | 174 | 159 |
| 4 | 162 | 161 | 159 | 234 | 160 | 160 | 169 | 160 |

Footnote to Table 2
The numbers, DEG, EG and GLY are as explained in the footnote to Table 1.

1. A composition comprising a disperse dyestuff having an average particle size of from 10 to 500 nm, a dispersant, water and a water-miscible co-solvent having a degree of polarity (δ/MPa^{1/2}) of from 4 to 14 at 25° C.

2. A composition as claimed in claim 1 wherein the average particle size is not greater than 200 nm.

3. A composition as claimed in either claim 1 or claim 2 wherein the degree of polarity is not greater than 12.5.

4. A composition as claimed in any one of claims 1 to 3 wherein the degree of polarity is not less than 10.

5. A composition as claimed in any one of claims 1 to 4 wherein the co-solvent has a solubility parameter as determined by H-bonding greater than 20.5 at 25° C.

6. A composition as claimed in any one of claims 1 to 5 wherein the co-solvent is ethyleneglycol, glycerol, 1,4-butanediol or resorcinol.

7. A composition as claimed in any one of claims 1 to 6 wherein the dispersant is nonionic or anionic.

8. A composition as claimed in claim 7 wherein the nonionic dispersant is an alkoxylate derivative of C₁₋₃₀-alk(en)yl alcohol, C₁₋₂₀-alkylphenol or a naphthol.

9. A composition as claimed in claim 7 wherein the anionic dispersant is a lignosulphonate, a phenyl or naphthylsulphonic acid formaldehyde condensate or an alkoxylate containing one or more carboxylic acid, sulphonic acid or phosphonic acid groups.

10. A composition as claimed in any one of claims 1 to 9 wherein the amount of dispersant is from 5 to 150% based on the amount of disperse dyestuff.

11. A composition as claimed in any one of claims 1 to 10 wherein the amount of disperse dyestuff is from 0.1 to 60% based on the amount of the composition.

12. An ink jet printing ink comprising 0.1 to 20% disperse dyestuff, water and from 5 to 30% co-solvent having a degree of polarity of not greater than 12.5 at 25° C., relative to the total amount of ink.

13. An ink as claimed in claim 12 which has a viscosity of from 1 to 40 cps as measured at 25° C.

14. A cartridge containing one or more outlets and a chamber containing the ink jet printing ink as claimed in claim 12 which is connected to each outlet.

15. The use of an ink as claimed in claim 12 for printing a synthetic substrate.

16. A process for printing a synthetic substrate which comprises printing the synthetic substrate with a printing ink as claimed in claim 12 and then subjecting the printed synthetic substrate to a heat treatment.
